(19) United States
(12) Patent Application Publication
(10) Pub. No.: US 2004/0108611 A1
(43) Pub. Date: Jun. 10, 2004

(54) Injecting liquid additives into plastic extruders

(76) Inventors: Michael D. Dennis, Crawfordsville, IN (US); Joseph K. Koreck, Crawfordsville, IN (US); Gayle L. Johnson, Crawfordsville, IN (US); Mark A. Powell, Crawfordsville, IN (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/315,349

(22) Filed: Dec. 10, 2002

(51) Int. Cl. B29C 47/00

(52) U.S. Cl. 264/39; 264/211; 425/208; 425/209; 425/378.1

(57) ABSTRACT

An apparatus for extruding plastic, including a plastic feed, an extruder, a colored liquid additive supply, a positive displacement metering pump, and a controller. The extruder has a housing receiving plastic from the plastic feed, a heat source, and a screw adapted to drive plastic through the housing The pump supplies colored liquid additive from the supply to the plastic in the phase change section of the extruder housing. The controller controls the drive rate of the screw and the pump to supply a selected volume of colored liquid additive per unit of time which is based on the drive rate of the screw. In use, the extruder is converted to adding a different color without cleaning the housing feeding section.

### BACKGROUND OF THE INVENTION

The present invention is directed toward plastic extrusion, and particularly toward adding colored liquid additive to extruded plastic.

Plastic is commonly formed via extrusion to provide a malleable plastic substance which can be formed, typically via molding, in a desired shape. Generally, extrusion is accomplished by supplying thermoplastic resins in a pellet form to a hopper chamber mounted on top of an extruder, with the pellets gravity fed into the rear of the extruder. From the rear of the extruder, a screw drives the material forward through a barrel, in which the material is heated both via the action of the screw (e.g., friction heat from the material forced against the barrel surface by the screw) and via heaters supplying heat to the barrel, producing a malleable extruded plastic material which can be manipulated as desired downstream of the extruder. For example, the plastic material can be cooled, cut to a desired quantity (e.g., for making discrete objects), molded to a desired shape, and then handled for further use (e.g., bottle caps may be transported to a bottling operation where they can be suitably secured on bottles after they are filled).

Generally, the plastic which is being extruded is compounded into a particular color. This is typically accomplished by adding colorants to the material hopper, with the colorants then fed into the extruder along with the plastic pellets. One method for coloring high impact styrene, a commonly used material for plastic extrusions in displays, is accomplished by using a dry color blend which is mixed with plastic pellets. Commonly, such dry color can be produced quickly and inexpensively, even in small quantities. Plastic pellets impregnated with pigments are also used, with small quantities of such impregnated pellets added to the extruder hopper with the plastic pellets. However, such impregnated pellets may not be suitable for small runs since the producers of such pellets usually require a large minimum order. The plastic pellets themselves can also be pre-colored by their manufacturers, though these too usually require a large minimum order.

As already mentioned, some of the coloring methods are not economical to use when only short runs are being made to produce relatively few parts having a particular color. Further, particularly when short runs are done, changing from one color to another can also be extremely inefficient, as the entire extruder barrel and much of the plastic pellet hopper must be opened and cleaned in order to remove remnants of the color which is no longer to be used to prevent it from contaminating the desired color of the plastic extruded thereafter for a different product.

The present invention is directed toward overcoming one or more of the problems set forth above.

### SUMMARY OF THE INVENTION

In one aspect of the invention, an apparatus for extruding plastic is provided, including a plastic feed hopper, an extruder, a liquid additive supply, a pump adapted to supply liquid additives from the liquid additive supply, and a controller. The extruder has a housing with an input adapted to receive plastic from the hopper, a heat source, and a screw adapted to drive plastic through the housing from the plastic feed to the output, where the housing includes a feeding section, a phase change section in which the plastic undergoes a phase change from solid to liquid, and a mixing section. The pump supplies liquid additive to the plastic in the phase change section. The controller is adapted to control the drive rate of the screw, and control the liquid pump to supply a selected volume of liquid additive per unit of time which is based on the drive rate of the screw.

In another aspect of the present invention, a method of extruding plastic is provided, including (a) feeding a plastic material into an extruder, (b) driving the plastic material through an extruder barrel at a selected rate, and (c) feeding a selected amount of colored liquid additive per unit of time to the extruder barrel phase change section, the selected amount of colored liquid additive per unit of time being based on the selected rate of driving the plastic material.

With this invention, the selected amount of colored liquid additive per unit of time is uniformly fed into the phase change section for each selected rate of driving the plastic material.

Additionally with this invention, the selected amount of colored liquid additive per unit of time is proportionate to the selected rate of driving the plastic material.

In still another aspect of the present invention, a method of extruding plastic of different colors is provided, including (a) feeding a plastic material into an extruder, (b) driving the plastic material through an extruder barrel at a selected rate, (c) feeding a selected amount of a first colored liquid additive per unit of time to the extruder barrel phase change section. The selected amount of the first color per unit of time is based on the selected rate of driving the plastic material. (i) Changing to a second color by stopping the feeding and driving steps, (ii) cleaning the extruder barrel from its output end to the location where the colored liquid additive is fed into the extruder, (iii) resuming steps (a) and (b), are resumed then (iv) feeding a selected amount of a second colored liquid additive per unit of time to the extruder barrel phase change section, the selected amount per unit of time being based on the selected rate of driving the plastic material and the physical properties of the second colored liquid additive in reference to the plastic output.

The selected amount of colored liquid additive per unit of time in the feeding steps is substantially uniformly fed into the phase change section for each selected rate of driving the plastic material flow.

In another form of this aspect of the invention, the selected amount of colored liquid additive per unit of time in the feeding steps is proportionate to the selected rate of driving the plastic material.

In still another form of this aspect of the invention, all of the extruder barrel is cleaned in the cleaning step except the feeding section since the colored liquid additive is added in the phase change section. The Liquid Pumping system is cleaned separately off line.

### BRIEF DESCRIPTION OF THE DRAWINGS

FIG. 1 is a partially broken away side view of an extruder embodying the present invention; and

FIG. 2 is a flow chart illustrating the steps of changing color in accordance with the present invention.

### DETAILED DESCRIPTION OF THE INVENTION

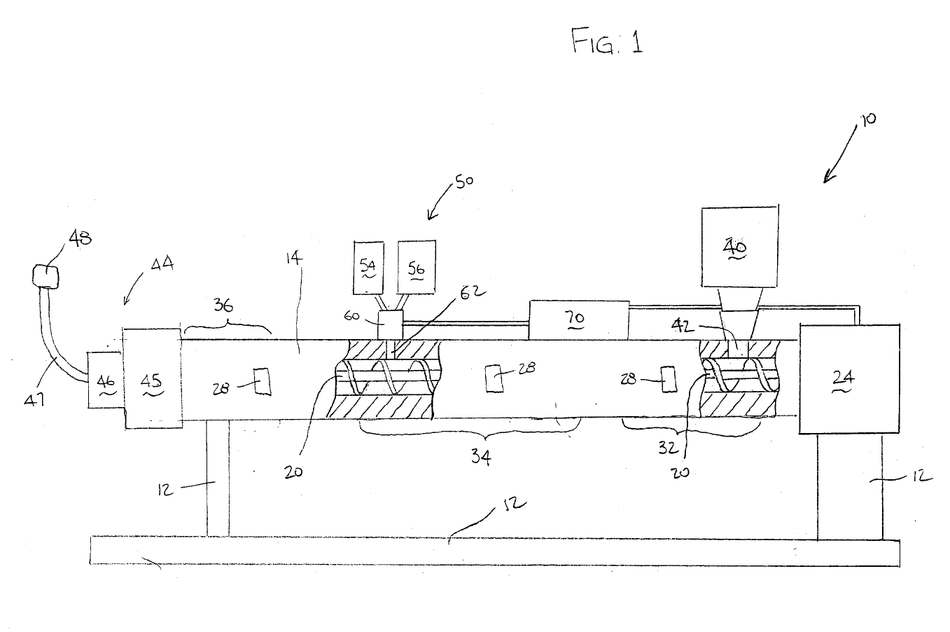

FIG. 1 illustrates an extruder 10 having a base 12 supporting an extruder housing or barrel 14. A suitable screw such as a barrier feed screw 20 is supported in the barrel 14 and is rotatably driven on one end by a suitable drive 24 (typically including a motor and gearbox). Suitable heaters (represented at 28) are provided along the barrel 14 to assist in the extrusion process.

Plastic material which is driven in the barrel 14 passes through three sections: the feed section 32, the barrier section 34, and the mixing section 36. The feed section 32 is the input portion of the barrel 14 where the plastic material is added. The barrier section 34 is the phase change section in which the plastic material is changing from solid to liquid. The mixing section 36 is adjacent the output end of the barrel 14 and is the portion in which the liquid plastic material is completely mixed. Typically the feed section 32 comprises about 30% of the length of the extruder barrel 14, the barrier section 34 comprises about 50%-60% of the length of the extruder barrel 14, and the mixing section 36 comprises about 10%-20% of the length of the extruder barrel 14. While there is no precisely defined delineation of these sections when the extruder is manufactured (as indicated by the general indication of the sections in FIG. 1), it is well within the ordinary skill of those in this art to reliably identify the barrier section 34 of the extruder barrel 14 in which phase change from solid to liquid is occurring.

A material hopper 40 is adjacent the drive 24 and suitably supplies plastic material through an opening 42 in the barrel 14 to the feed section 32 of the barrel 14. Any plastic which may be extruded may be used in connection with the present invention including, but not limited to, high impact styrene, rigid and flexible polyvinyl chloride, butyrate, ABS, polyethylene, acrylic (sold by AutoHaas, Americas Inc. under its Plexiglass trademark), SAN, polypropylene, and K-Resin (a registered trademark of Phillips 66 Co.). Such plastics have different characteristics (e.g., toughness, transparency/translucency) which may be selected based on the desired characteristics of the product being produced. All may also be colored as desired, with even transparent materials occasionally colored to provide a tint.

Commercially available colored liquid additives such as those available from Rite Systems or Chroma Injecta Color Corp products are appropriate for use in this invention. Selection of the Colored liquid additive is dependant on the rheological properties of the additive in conjunction with the properties of the plastic being processed. Strict control of both viscosity and weight per gallon of the additives are required both for comparability and process control. Tight control of Let Down Ratio is also required for minimal cost implications of the colored plastic.

Opposite the drive 24 is the output end 44 of the extruder 10, where extruded plastic is output for further processing, such as molding to discrete, desired shapes. As illustrated, the output end 44 includes a screen changer 45, a metering pump 46, a flexible hose 47, and a nozzle 48 which may be positioned to direct the extruded plastic as desired for further processing. It should be understood, however, that the present invention could be used with essentially any extruder no matter what the configuration of the output end 44.

Further, although reference herein is made to color liquid additives, it should be appreciated that the present invention could be advantageously used with essentially any liquid additives which may be used when extruding plastic.

A colored liquid additive supply station 50 is provided on the extruder barrel 14 as shown in FIG. 1. As illustrated, two hoppers 54, 56 containing different colored liquid additives are attached to a pump 60 to selectively provide colored liquid additive through an opening 62 in the barrel 14 to the barrier section 34 of the barrel 14. It has been found that injecting colored liquid additives such as described herein in the barrier section 34 of the barrel 14 will allow for sufficient mixing of the color and plastic so that the output extruded plastic will have a consistent, uniform color as is most commonly highly desired.

It should be understood that any number of colored liquid additive hoppers could be used within the scope of the present invention. For example, a single hopper could be used with the pump 60 to provide a single colored liquid additive, with the hopper replaced with a different hopper having a different colored liquid additive when the color of the extruded plastic is to be changed. Further, multiple hoppers (such as the two hoppers 54, 56 illustrated) could be used, with the colored liquid additive from one or the other selectively injected by the pump 60, or a combination of colored liquid additives injected to provide mixed color. It would also be within the scope of the present invention to provide multiple colored liquid additive supply stations (i.e., multiple pumps), with each pump selectively providing a different colored liquid additive, either separately or simultaneously, again depending on the desired end color of the extruded plastic.

The pump 60 may be a high pressure pump with an injection valve so as to provide a steady selected amount of colored liquid additive to the barrel 14 as described hereafter. It should be recognized that as the screw 20 turns through a single revolution, the pressure at the opening 62 in the outer wall of the barrel 14 can vary, for example, from 0 psi to 1500 psi. It is desirable for the pump 60, which is injecting colored liquid additive at this location, to be able to provide a steady stream of colored liquid additive notwithstanding this wide variance of pressures which must be overcome to inject the color. A positive displacement metering pump, which operates to provide an highly accurate steady volume of liquid output independent of the pressure at the output source, is suitable for this purpose.

A suitable controller 70 may be used to tie the drive 24 to the pump 60 whereby the pump 60 provides a selected volume of colored liquid additive based on the drive rate of the screw 20. That is, the controller 70 may control the rate of rotation of the drive screw 20 (or, if the rate is controlled separately, detect the rate of rotation) and then control the pump 60 to inject colored liquid additive to the phase change section 34 of the barrel 14 at a rate which is based on the screw rotation rate. Accordingly, if the rotation rate of the screw 20 is increased to drive greater amounts of plastic through the barrel 14 in a given unit of time, the pumping rate of the pump 60 is similarly increased to pump proportionately greater amounts of colored liquid additive into the barrel 14.

It should therefore be appreciated that extruders embodying the above described invention will only have coloring material (i.e., colored liquid additive) downstream from the color supply station 50, and particularly will not have coloring material in the areas of the feeding section 32 and the material hopper 40. Therefore, change to production of a different colored extruded plastic can be more quickly and efficiently accomplished than with the previously described prior art extruders in which the entire barrel, including the feeding section, had to be cleaned. The present invention therefore not only wastes less material (i.e., there is no colored material in the feeding section which must be discarded during change-over to a new color), but also requires less of the extruder 10 to be cleaned and therefore results in less down time of the machine. Particularly where small runs of different colors are being done, this reduced down time between runs can be a significant factor in maximizing productive use of the apparatus.

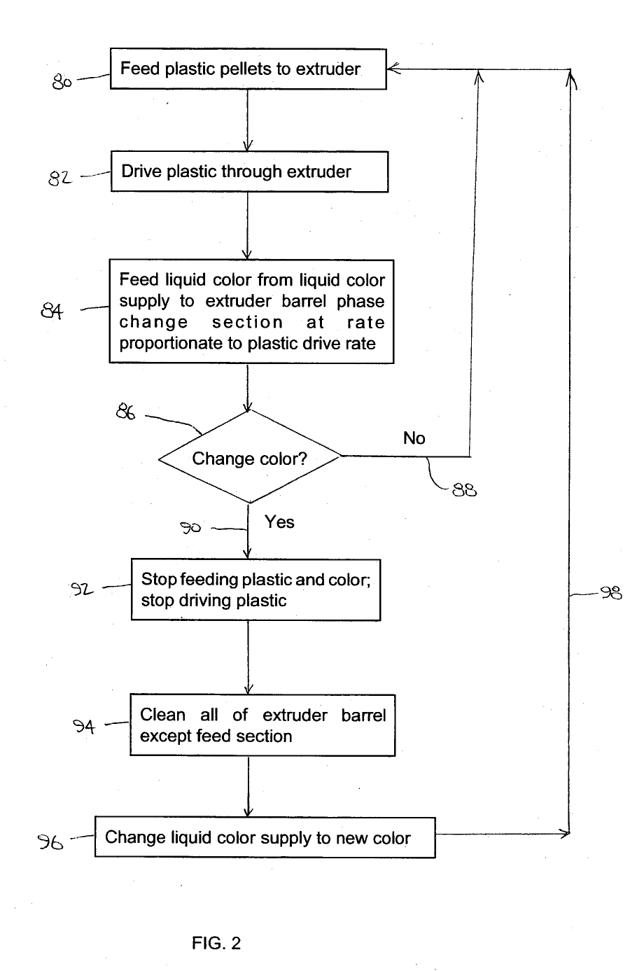

FIG. 2 illustrates the flow of this advantageous operation.

Specifically, as the extruder 10 operates to produce extruded colored plastic, plastic pellets are fed to the extruder 10 (box 80), the plastic is driven through the extruder 10 (box 82), and colored liquid additive is fed to the barrel phase change section at a rate proportionate to the drive rate of the plastic such as previously described (box 84). Such operation continues so long as there is no decision made (box 86, path 88) to change the color.

When it is desired to change to production of extruded plastic of a different color (box 86, path 90), the extruder is stopped (box 92) and then all of the barrel except the feed section is cleaned (box 94). As already mentioned, this limited cleaning not only reduces the down time of the extruder, but also reduces the amount of wasted material when compared with changing color with the described prior art extruders. The colored liquid additive supply is then changed to a new color (box 96) (whether by adding a new hopper with different colored liquid additive or by changing the input of the pump 60 between multiple hoppers 54, 56), and then operation resumes (path 98) with plastic and liquid again fed to the extruder 10 and the extruder 10 driven.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. An apparatus for providing extruded plastic, comprising:
a plastic feed;
an extruder having
a housing with an input and an output, said input adapted to receive plastic from said plastic feed,
a heat source,
a screw adapted to drive plastic through said housing from said plastic feed to said output,
wherein said housing includes a feeding section, a phase change section in which said plastic undergoes a phase change from solid to liquid, and a mixing section;
a liquid additive supply;
a pump adapted to supply liquid additive from said liquid additive supply through said housing to said plastic in said phase change section; and
a controller adapted to
control the drive rate of said screw, and
control the pump to supply a selected volume of liquid additive per unit of time which is based on the drive rate of said screw.

2. The apparatus of claim 1, wherein said pump is a positive displacement metering pump.

3. The apparatus of claim 1, wherein said extruder housing is a barrel enclosing said screw.

4. The apparatus of claim 1, wherein said screw turns at a selected rate to drive plastic through said housing, and said controller controls said pump to supply said colored liquid additive at a rate proportionate to said screw turn selected rate.

5. The apparatus of claim 1, wherein the liquid additive is adapted to color the plastic.

6. An apparatus for providing extruded plastic, comprising:
a plastic feed;
an extruder having
a housing with an input and an output, said input adapted to receive plastic from said plastic feed,
a heat source,
a screw adapted to drive plastic through said housing from said plastic feed to said output,
wherein said housing includes a feeding section, a phase change section in which said plastic undergoes a phase change from solid to liquid, and a mixing section;
a liquid additive supply; and
a positive displacement metering pump adapted to supply liquid additive from said liquid additive supply through said housing to said plastic in said phase change section.

7. The apparatus of claim 6, wherein said screw turns at a selected rate to drive plastic through said housing, and further comprising a controller controlling said pump to supply said liquid additive at a rate proportionate to said screw turn selected rate.

8. The apparatus of claim 6, wherein the liquid additive is adapted to color the plastic.

9. A method of extruding plastic, comprising:
feeding a plastic material into an extruder;
driving said plastic material through an extruder barrel at a selected rate, said extruder barrel including a feeding section, a phase change section in which said plastic material undergoes a phase change from solid to liquid, and a mixing section;
feeding a selected amount of liquid additive per unit of time to said extruder barrel phase change section, said selected amount of liquid additive per unit of time being based on said selected rate of driving said plastic material.

10. The method of claim 9, wherein said selected amount of liquid additive per unit of time is substantially uniformly fed into said phase change section for each selected rate of driving said plastic material.

11. The method of claim 9, wherein said selected amount of liquid additive per unit of time is proportionate to said selected rate of driving said plastic material.

12. The method of claim 9, wherein the liquid additive colors the plastic.

13. A method of extruding plastics with different additives, comprising:
feeding a plastic material into an extruder;
driving said plastic material through an extruder barrel at a selected rate, said extruder barrel including a feeding section at an input end, a phase change section in which said plastic material undergoes a phase change from solid to liquid, and a mixing section at an output end;
feeding a selected amount of a first liquid additive per unit of time to said extruder barrel phase change section, said selected amount of said first liquid additive per unit of time being based on said selected rate of driving said plastic material;
changing to a second liquid additive by
stopping said feeding and driving steps,
cleaning said extruder barrel from said output end to the location where said liquid additive is fed into said extruder,
resuming said feeding said plastic material step and said driving step; and
feeding a selected amount of said second liquid additive per unit of time to said extruder barrel phase change section, said selected amount per unit of time being based on said selected rate of driving said plastic material.

14. The method of claim 13, wherein said selected amount of liquid additive per unit of time in said feeding steps is substantially uniformly fed into said phase change section for each selected rate of driving said plastic material.

15. The method of claim 13, wherein said selected amount of liquid additive per unit of time in said feeding steps is proportionate to said selected rate of driving said plastic material.

16. The method of claim 13, wherein all of said extruder barrel is cleaned in said cleaning step except said feeding section.

17. The method of claim 13, wherein the first liquid additive colors the plastic a first color and the second liquid additive colors the plastic a second color different than said first color.
